(19) United States
(12) Patent Application Publication
(10) Pub. No.: US 2008/0101995 A1
(43) Pub. Date: May 1, 2008

(54) Ion mobility spectrometer having improved sample receiving device

(75) Inventors: Ted Gabowitcz, Mississauga (CA); Dragoljub Ridjosic, Mississauga (CA); Sabatino Nacson, Thornhill (CA)

Correspondence Address: FOLEY AND LARDNER LLP;SUITE 500, 3000 K STREET NW, WASHINGTON, DC, 20007, US

(73) Assignee: SMITHS DETECTION INC.

(21) Appl. No.: 11/303,012

(22) Filed: Dec. 16, 2005

(51) Int. Cl. B01L 3/00

(52) U.S. Cl. 422/99; 436/173

(57) ABSTRACT

A sample receiving device that properly aligns a sample collection device for introduction into an analytical device is provided. A sample collection device can include a guide structure or plurality of guide structures that guide and align a sample collection device within the sample receiving device so that the sample collection device is properly aligned to facilitate sample introduction.

### BACKGROUND

Trace analyte detection has numerous applications, such as screening individuals and baggage at transportation centers, mail screening, facility security applications, military applications, forensics applications, narcotics detection and identification, cleaning validation, quality control, and raw material identification. Trace analyte detection is the detection of small amounts of analytes, often at nanogram to picogram levels. Trace analyte detection can be particularly useful for security applications such as screening individuals or items for components in explosive materials, narcotics or biological contaminants where small amounts of these components are deposited on the individual or on the surface of a package or bag.

Trace analysis is also important in pharmaceutical manufacturing. See, e.g., Tan and DeBono, Today's Chemist at Work; p. 15-16, 2004 and Munden et al., Pharm. Tech. Eur. Oct. 1, 2002. During the development of a manufacturing process and periodically thereafter, each piece of equipment must be verified, preventing contamination of pharmaceutical ingredient by contact with unclean equipment surfaces. Equipment surfaces are sampled and analyzed for trace contaminants. According to the Food and Drug Administration guidelines chemical residues in manufacturing equipment must be reduced to an acceptable level.

A variety of different techniques can be used for trace analyte detection. These methods include ion mobility spectrometry (IMS), mass spectrometry, gas chromatography, liquid chromatography, and high performance liquid chromatography (HPLC).

IMS is a particularly useful technique for rapid and accurate detection and identification of trace analytes such as narcotics, explosives, and chemical warfare agents. The fundamental design and operation of an ion mobility spectrometer is addressed in, for example, Ion Mobility Spectrometry (G. Eiceman and Z. Karpas, 2d Ed., CRC Press, Boca Raton, Fla., 2004). IMS detects and identifies known analytes by detecting a signal which is unique for each analyte. IMS measures the drift time of ions through a fluid, such as clean, dry ambient air at atmospheric pressure. Analysis of analytes in a sample begins with collection of a sample and introduction of the sample into the spectrometer. A sample is heated to transform analyte from solid, liquid or vapor preconcentrated on a particle into a gaseous state. Analyte molecules are ionized in the reaction region of the IM spectrometer. Ions are then spatially separated in the IMS drift region in accordance to their ion mobility, which is an intrinsic property of an ion. Often, an induced current at the collector generates a signature for each ion as a function of the time required for that ion to reach the collector. This signature can be used to identify a specific analyte.

An advantage of using IMS for trace detection is the ability to analyze a sample in both positive and negative mode and using different ionization reagents to identify substances that cannot be differentiated by other methods. For example, ranitidine and cocaine have similar mobility constants in the positive mode. However, only ranitidine is ionized in the negative ion mode, allowing differentiation of ranitidine and cocaine when the positive and negative mode data both are collected and analyzed. Additionally, ammonium nitrate can be difficult to distinguish from other analytes containing ammonium ions or nitrate ions, but can be differentiated when the results from both positive and negative mode ionization are analyzed.

Conventional trace detection analysis systems typically rely on the operator to ensure that the sample collection area of the sampling substrate material (or “swab”) is properly aligned within an analyzer, so that the portion of the substrate material containing the sample is actually analyzed by the analytical device. For example, in IMS it is necessary that the collected sample is properly aligned on the sample desorber such that the collected sample is desorbed and analyzed by the IMS. When the sample area of the substrate is not properly aligned within the analyzer, the collected sample cannot be completely desorbed. Therefore, the test results of the sample can be affected by how the sample area of the substrate is aligned within the analyzer, making the accuracy of the analysis dependent, in part on the ability and care of the operator.

### SUMMARY OF THE INVENTION

Thus, there is need in the art for a trace analyte detection system that provides a way of properly aligning a sample within the system to avoid error in positioning the collected sample in an analytical device.

Accordingly, one embodiment provides a sample receiving device includes a sample introduction area where a sample is positioned for introduction into an analytical device, and a guide structure that receives a sample collection device within the sample receiving device, wherein the sample collection device is properly aligned within the analytical device for optimal or substantially optimal introduction of the sample on the sample collection device into the analytical device.

Another embodiment provides an ion mobility spectrometry system includes an ion mobility spectrometer, a sample receiving device, wherein the sample receiving device includes a sample introduction area where a sample is positioned for introduction into an analytical device, and a guide structure that receives a sample collection device within the sample receiving device, wherein the sample collection device is properly aligned within the analytical device for optimal or substantially optimal introduction of the sample on the sample collection device into the analytical device, and a desorber.

A further embodiment provides an ion mobility spectrometry system includes a first ion mobility spectrometer, comprising a drift tube, a reagent introduction device, an ionization region, an ionization source, and a detector; a second ion mobility spectrometer, comprising a drift tube, a reagent introduction device, an ionization region, an ionization source, and a detector; at least one ionization source; and a sample receiving device for receiving a sample collection device, wherein the sample receiving device includes a sample introduction area where a sample is positioned for introduction and analysis, and a guide structure that receives and aligns the sample collection device within the sample receiving device, wherein the sample collection device is properly aligned within the system for optimal or substantially optimal introduction of the sample on the sample collection device.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages will become apparent from the following description, appended claims, and the accompanying exemplary embodiments shown in the drawings, which are briefly described below.

FIG. 1 shows an exploded view of a sample receiving device.

FIG. 2 is a perspective view of a sample receiving device.

FIG. 3 shows a view of a sample receiving device with a control line and a bracket in exploded view.

FIG. 4 shows a perspective view of a sampling wand.

FIG. 5 shows a perspective view of a sampling wand inserted into a sample receiving device.

FIGS. 6 is a perspective view of a sample receiving device with a sample head of a sampling wand inserted into the sample receiving device.

FIG. 7 is an end view of a sample receiving device with a sample head of a sampling wand inserted into the sample receiving device.

FIG. 8 is a perspective view of an IMS analyzer with an inserted sampling wand.

FIG. 9 is a top view of an IMS analyzer with an inserted sampling wand.

FIG. 10 is a top sectional view of an IMS analyzer with an inserted sampling wand.

FIG. 11 is a perspective view of a manual sampling substrate.

FIG. 12 illustrates an embodiment when a manual sampling substrate is initially inserted into an IMS analyzer.

FIG. 13 illustrates an embodiment after an operator has completed insertion of a manual sampling substrate into an IMS analyzer.

FIG. 14 shows a view from an end of a manual sampling substrate after a manual sampling substrate has been inserted into an IMS analyzer.

FIG. 15 is a top view that shows a manual sampling substrate inserted into an IMS analyzer, where a cover of an IMS analyzer has been removed to show an exemplary interface of a manual sampling substrate with an IMS analyzer.

FIG. 16 is a perspective view of an IMS analyzer.

FIG. 17 is a sectional view of an IMS analyzer from the top, showing components of an IMS analyzer.

FIG. 18 shows an example of a detection peak pattern for Ranitidine in positive ion mode.

FIG. 19 shows an example of detection peak pattern for Ranitidine in negative ion mode.

FIG. 20 shows an example of detection peak pattern for cocaine in negative ion mode.

FIG. 21 shows an example of detection peak pattern for ammonium in positive ion mode.

FIG. 22 shows an example of detection peak pattern for nitrate in negative ion mode.

### DETAILED DESCRIPTION

The inventors have discovered a sample receiving device having improved operation and alignment characteristics. A sample receiving device can be arranged to receive a sample collection device so that the sample collection device is properly aligned for introduction of a sample into an analytical device. A sample is collected onto a sample collection device, which can be inserted into the sample receiving device. A sample receiving device can include a sample introduction area where a sample area of a sample collection device can be positioned for introduction of the sample into the analytical device for analysis. A sample collection device can include a guide structure or plurality of guide structures that guide and align the sample collection device within the sample receiving device so that the sample collection device is properly aligned to facilitate sample introduction.

“Sample” refers, without limitation, to any molecule, compound or complex that is adsorbed, absorbed, or imbedded on or within a sample collection device. A sample can contain an analyte of interest, referred to herein as an “analyte” or “sample analyte,” which is understood to be any analyte to be detected using a detection technique. A “sample” can be a liquid, vapor, gas, particulate, solid, or any combination of these phases of matter. A “sample collection device” can include a swab, a manual sampling substrate, a sampling wand, or other sample collection device known in the art.

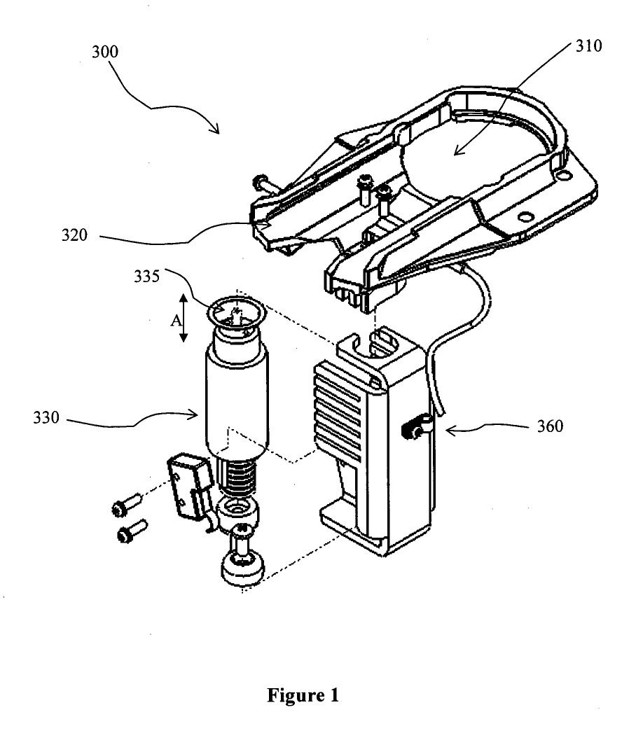

FIGS. 1-3 show an embodiment of a sample receiving device. A sample receiving device 300 can include a sample introduction area 310, a guide structure or plurality of guide structures 320, and optionally, a locking mechanism 330.

FIG. 1 shows an exploded view of a sample receiving device 300. A sample receiving device 300 can include a guide structure or plurality of guide structures 320 to guide and align a sample collection device within a sample receiving device 300. Any suitable guide structure can be used, such as, for example, slots, rails, pins, slides, grooves, or any other suitable alignment structures known in the art. Guide structures 320 can be any appropriate dimension. In one embodiment, the guide structure can correspond to a dimension of a sample collection device. According to this embodiment, a sample area of a sample collection device can be properly aligned within an analytical device so that a collected sample can be positioned within the device for optimal or substantially optimal introduction of the sample into the analytical device, providing accurate analysis of the sample. According to this embodiment, an operator with little or no training can insert a sample collection device into an analytical device so that the sample area of a sample collection device can be properly aligned within an analytical device so that a collected sample can be positioned within the device for optimal or substantially optimal introduction of the sample. For example, a sample collection device can be properly aligned so that complete or substantially complete desorption of a sample can occur, permitting accurate analysis of the sample.

An analytical device can be, for example, an IMS, an IMS-IMS, or a gas chromatographer-IMS. In one embodiment, the analytical device is an IM spectrometer. In another embodiment the analytical device is an IMS system having two IM spectrometers.

A sample receiving device 300 can include a locking mechanism 330 for locking a sample collection device in position within a sample receiving device 300. A locking mechanism 330 can be positioned in a sample receiving device 300 by a locking mechanism housing 360. A locking mechanism 330 can include a locking device that engages with a sample collection device to retain a sample collection device within a sample receiving device 300 during sample analysis, or at least during introduction of a sample into an analytical device, maintaining a position of a sample area of a sample collection device in a sample introduction area 310. A locking mechanism 330 can be any suitable mechanism, including, for example, a pin, snap device, bayonet fastener, solenoid, or other fastening device. For example, as shown in FIG. 1, a locking mechanism 330 is a solenoid that, when activated, moves a pin 335 in a direction indicated by arrow A. In this embodiment, a solenoid can be activated to extend a pin 335 upwards so that a pin 335 engages with a sample collection device. Once analysis, or at least sample introduction, is complete, a solenoid can be activated to retract a pin 335 and allow a sample collection device to be removed from a sample receiving device 300.

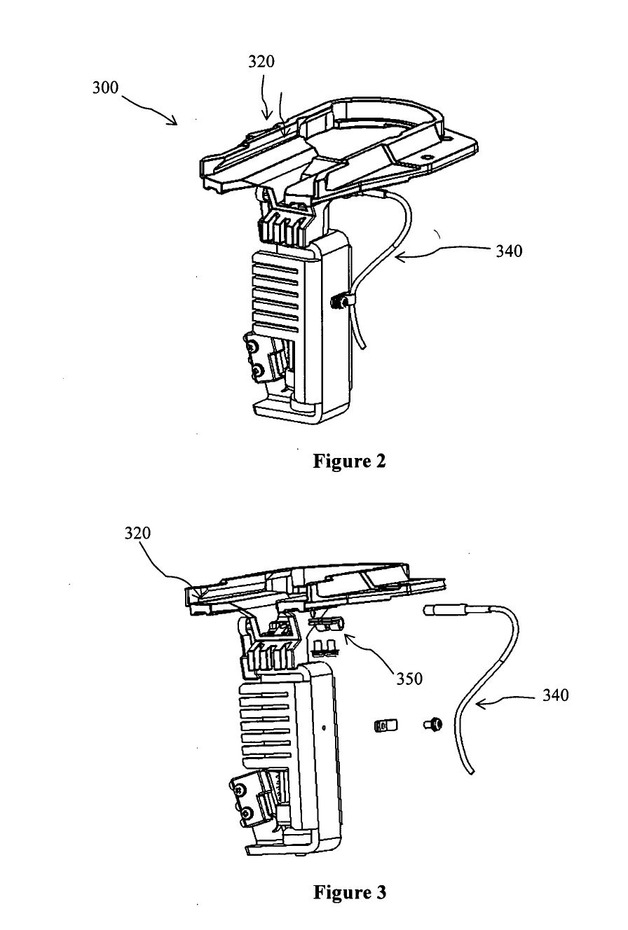

FIG. 2 is a perspective view of a sample receiving device that includes a control line for a locking mechanism 330. FIG. 3 shows a view of a sample receiving device 300 with a control line 340 for a locking mechanism 330 and bracket 350 in exploded view. A bracket 350 can be used to fix a control line 340 to a sample receiving device 300.

According to an embodiment, a sample receiving device can be arranged to automatically start analysis of a sample when sample collection device is inserted into a sample collection device. Therefore, a sample receiving device can start sample introduction and analysis of a sample without requiring any additional action by an operator for analysis to begin. For example, an automatic start device can automatically begin analysis of a sample on a sample collection device upon insertion into a sample receiving device. An automatic start device can be, for example, an optical sensor, a sensor with a light beam that is broken by a sample collection device to trigger a signal, a sensor with a laser beam that is broken by a sample collection device to trigger a signal, a Hall sensor, or a mechanical switch, such as a pin, lever, or other mechanical device that engages with a sample collection device.

In one embodiment, insertion of a sampling head 210 into a sample receiving device 300 can cause an IMS analyzer to begin analysis of a sample, thus requiring no additional action by an operator for analysis to begin. In another embodiment, analysis can be started once a sample area of the sample collection device is positioned at a sample receiving area of a sample receiving device. Alternatively, an operator can insert a sample collection device and then initiate sample introduction and analysis manually.

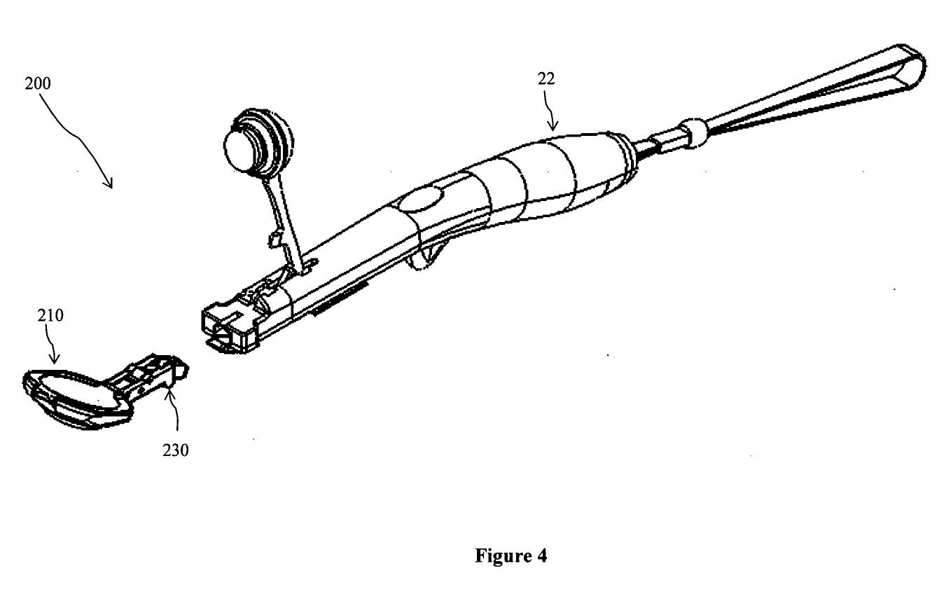

A sample receiving device can be arranged to be compatible with various sample collection devices. For example, the sample receiving device can be arranged to be compatible with a sampling wand (such as that shown in FIG. 4), a manual sampling substrate, or any other sample collection device known in the art. A sample collection device is useful for collecting samples containing of a wide range of analytes, including but not limited to explosives, narcotics, chemical warfare agents, toxins, pharmaceutical process contaminants, and other chemical compounds. Collected samples to be analyzed by an analyzing device may be liquid, solid, vapors pre-concentrated on solid absorbents, or other appropriate sample collection forms.

Explosives which can be collected using a sample collection device include, but are not limited to, 2-amino-4,6-dinitrotoluene, 4-amino-2,6-dinitrotoluene, ammonal, ammonium nitrate, black powder, 2,4-dimethyl-1,3-dinitrobutane, 2,4-dinitrotoluene, ethylene glycol dinitrate, forcite 40, GOMA-2, hexanitrostilbene, 1,3,5,7-tetranitro-1,3,5,7-tetrazacyclooctane (HMX), mononitrotoluene, nitroglycerine, pentaerythritol tetranitrate (PETN), 1,3,5-trinitro-1,3,5-triazacyclohexane (RDX), semtex-A, Semtex-H, smokeless powder, trinitro-2,4,6-phenylmethylnitramine tetryl (Tetryl), 2,4,6-trinitrotoluene (TNT), trilita, and 1,3,5-trinitrobenzene and combinations of these compounds. In one embodiment, the explosive which are collected are 1,3,5-trinitro-1,3,5-triazacyclohexane, pentaerythritol tetranitrate, 2,4,6-trinitrotoluene, trinitro-2,4,6-phenylmethylnitramine tetryl, nitroglycerine, ammonium nitrate, 3,5,7-tetranitro-1,3,5,7-tetrazacyclooctane, and combinations thereof.

Narcotics which can be collected using a sample collection device include, but are not limited to 6-acetylmorphine, alprazolam, amobarbital, amphetamine, antipyrine, benzocaine, benzoylecgonine, bromazepam, butalbital, carbetapentane, cathinone, chloradiazepoxide, chlorpheniramine, cocaethylene, cocaine, codeine, diazepam, ecgonine, ecognine methyl ester (EME), ephedrine, fentanyl, flunitrazepam, hashish, heroin, hydrocodone, hydromorphone, ketamine, lidocaine, lorazepam, lysergic acid diethylamide (LSD), lysergic acid, N-methyl-1-3(3,4-methylenedioxyohenyl)-2-butanamine (MBDB), 3,4-methylenedioxyamphetamine (MDA), DL-3,4-methylenedioxyethylamphetamine (MDEA), methylenedioxymethamphetamine (MDMA), marijuana, mescaline, methadone, methamphetamine, methaqualone, methcathinone, morphine, noscapine, opium, oxazepam, oxycodone, phencyclidine (PCP), pentobarbital, phenobarbital, procaine, psilocybin, secobarbital, temazepam, THC, THC-COOH, and triazolam. In one embodiment, the narcotics which can be collected with a sample collection device include cocaine, heroin, phencyclidine, THC, methamphetamine, methylenedioxyethylamphetamine, methylenedioxymethamphetamine, N-methyl-1-3(3,4-methylenedioxyohenyl)-2-butanamine, lysergic acid diethylamide, and combinations thereof.

Chemical warfare agents and other toxins that can be collected using a sample collection device include, but are not limited to amiton (VG), anthrax, arsine, cyanogen chloride, hydrogen chloride, chlorine, diphosgene, PFIB, phosgene, phosgene oxime, chloropicrin, ethyl N,N-dimethyl phosphoramicocyanidate (Tabun), isopropyl methyl phosphonofluoridate (Sarin), pinacolyl methyl phosphonefluoridate (Soman), phosphonofluoridic acid, ethyl-, isopropyl ester (GE), phosphonothioic acid, ethyl-, S-(2-(diethylamino)ethyl) O-ethyl ester (VE), phosphonothioic acid, methyl-, S-(2-(diethylamino)ethyl) O-ethyl ester (VM), distilled mustard, ethyldichloroarsine, lewisite 1, lewisite 2, lewisite 3, methyldichloroarsine, mustard-lewisite mixture, mustard-T mixture, nitrogen mustard 1, nitrogen mustard 2, nitrogen mustard 3, phenyldichloroarsine, phosgene oxime, sesqui mustard, adamsite, aflatoxin, botulinus toxin, ricin, saxitoxin, trichothecene mycotoxin, methylphosphonothioic acid S-(2-(bis(1-methylethyl)amino)ethyl) O-ethyl ester (VX), cyclohexyl methylphosphonofluoridate (GF), and combinations thereof.

Pharmaceutical process contaminants refers to any compound present on pharmaceutical manufacturing equipment, such as resulting from cross-contamination, which can adulterate an active pharmaceutical ingredient, excipient, or other pharmaceutical production materials. For example, a first compound is produced in a vat using a mixture of chemical ingredients and it is desired to use the same vat for a subsequent production run of a second compound. It is important that the first compound and materials from the production run not contaminate the second production run and thus cleaning is necessary. Such contaminants include, but are not limited to include detergents, sugars and other active pharmaceutical ingredients such as acetaminophen, alprazolam, baclofen, chlorpheniramine malate, chlorpromazine, ibuprofen, morphine, naproxen, oxycodone, pseudoephedrine, sennoside, and triclosan.

FIG. 4 shows an embodiment of a sampling wand 200. In this embodiment, a sampling wand 200 can use a replaceable sampling substrate that can be held in a device using any suitable substrate retaining arrangement. A substrate can be secured using, for example, a snap device, bezel, hook and loop, snap-fitting, or sandwich-type arrangement using a frame. For example, a sampling wand 200 can include a sampling head 210. In another example, a sample head 210 can be configured to support a substrate so that a sample area of a substrate is arranged to collect a sample.

According to an embodiment, a sampling head 210 can be removed from a body 220 of a sampling wand 200. A sampling head 210 can be attached to a body 220 by a connecting mechanism 230 to fasten a sampling head 210 to a body 220 of a sampling wand 200 so that a sampling head 210 can be readily attached to a body 220 of a sampling wand 200 and detached from a body 220 of a sampling wand 200. A connecting mechanism 230 can include any suitable fastening device capable of fastening a sampling head to a body of a sampling wand. Suitable fastening devices include, for example, a snap device, detent connection, bayonet fastener, interrupted thread, magnet, solenoid, or other fastening device known in the art. In one embodiment, a fastening device can be a magnet. A connecting mechanism 230 can include a fastening device in a sampling head 210 and a corresponding fastening device in a body 220 of a sampling wand 200.

The above example describes a sample receiving device as being used with a sampling wand that has a detachable sampling head. However, a sample receiving device can also be used with a sampling wand having a sampling head that is integral with a body of a sampling wand.

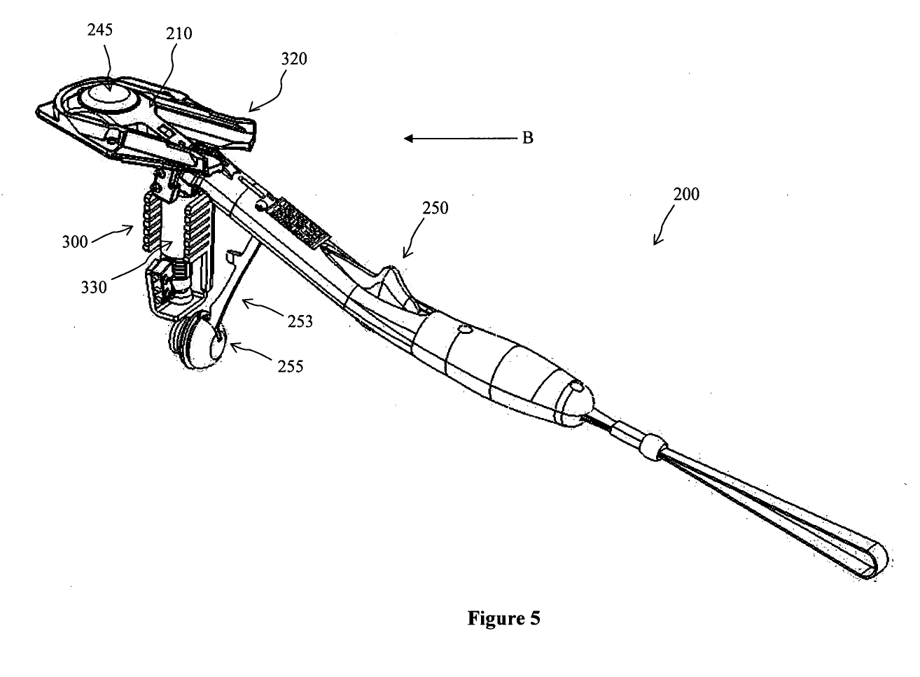

FIG. 5 shows an embodiment in which a sampling wand 200 is inserted into a sample receiving device 300. For example, a sampling head 210 can be properly aligned and guided as the sampling head 210 is inserted into a sample receiving device 300. A sample area 245 of a substrate 240 can be positioned in a sample introduction area 310 by inserting a sampling head 210 of a sampling wand 200 into a sample receiving device 300.

In the example shown in FIG. 5, a sampling area 245 of a substrate 240 is facing upwards and a swing arm 253 is operated to move a swing head 255 away from a substrate 240 so that a swing head 255 will not interfere with insertion of a sampling head 210 within a sample receiving device 300. A sampling wand 200 may include an activating device 250 to activate movement of a swing arm 253. As shown in FIG. 5, once a sampling wand 10 is arranged in this way, a sampling head 210 can be inserted into slots 320 of a sample receiving device 300 and a sampling head 210 and sampling wand 200 can be moved in a direction indicated by arrow B so that a sampling head 210 and sample area 245 are properly placed in a sample introduction area 310 and analysis of a collected sample can be performed. A sample receiving device 300 can be arranged in other ways so as to accept a sampling wand 200 at different orientations as well, such as a sampling wand 200 with a sample area 245 facing downwards.

Once a sample area 245 of a substrate 240 is aligned within an IMS analyzer, a sample contained on a substrate 240 can be introduced into an analytical device. In one embodiment, a substrate 240 can be heated and the sample desorbed. Proper alignment of a sample area 245 of a substrate 240 in a sample introduction area 310 can be achieved by insertion of a sampling wand 200 is inserted into a sample receiving device 300, allowing accurate analysis of a sample.

Once a sample is removed from a substrate, an operator can reattach a sampling head 210 to a body 220 of a sampling wand 200 and remove a sampling head 210 from an IMS analyzer. Furthermore, while sampling head 210 and substrate with a first sample are detached and placed within an IMS analyzer for analysis, an operator can attach a second or other additional sampling head 210 to a body 220 of a sampling wand 200 so that additional samples can be collected with a sampling wand 200 while a first sample is analyzed.

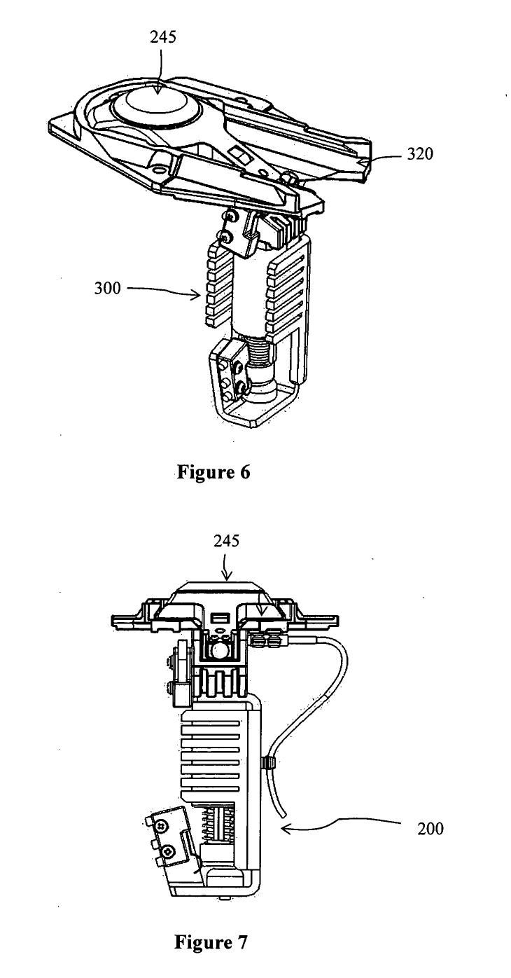

FIGS. 6 and 7 are perspective views of a sample receiving device 300 with a sample head 210 of a sampling wand 200 inserted into the sample receiving device 300, according to an embodiment.

A sample receiving device can be used in conjunction with an analytical device. In one embodiment, a sample receiving device can be in fluid connection with an IMS. In another embodiment, a sample receiving device can be in fluid connection with two or more IM spectrometers.

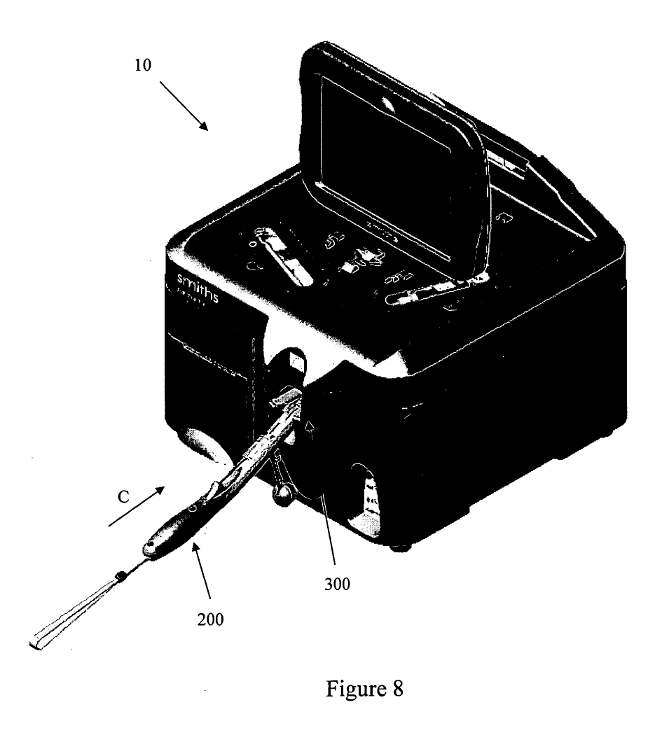

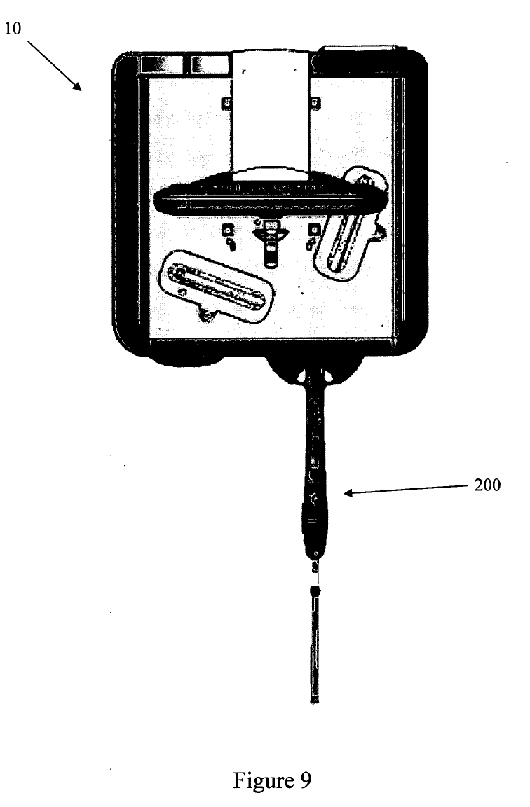

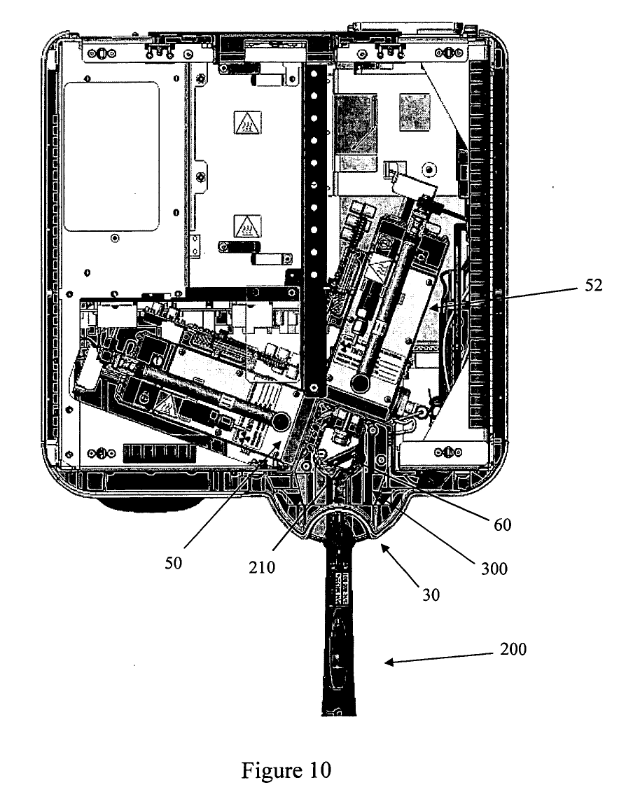

FIG. 8 shows a perspective view of an IMS analyzer 10 that includes an insertion area 30. FIG. 9 is a top view of an IMS analyzer 10 with an inserted sampling wand 200. FIG. 10 is a sectional top view showing an IMS analyzer 10 of FIG. 9 with an inserted sampling wand 200, according to an embodiment. A sampling wand 200 can be inserted into an insertion area 30 of an IMS analyzer 10 by moving a sampling wand 200 in the direction indicated by arrow C in FIG. 8. For example, an insertion area 30 of a sample receiving device 300 can be configured to receive a sample head 210 of a sampling wand 200 so that a sample that has been collected with a sampling wand 200 can be analyzed by an IMS analyzer 10.

As exemplified in FIG. 10, an analytical device can include two IM spectrometers 50, 52. In another embodiment, an analytical device can include a single IM spectrometer instead of two IM spectrometers. A single desorber 60 can be associated with IM spectrometers 50, 52, as shown in FIG. 10, or each IM spectrometer can be associated with a dedicated desorber. According to an embodiment, a desorber can be a heated anvil. According to an embodiment, a desorber can be integral to a sample receiving device.

According to an embodiment, a sampling wand 200 can include an incremental counter that indicates the number of desorption cycles for a sampling head 210 and/or substrate 240. The incremental counter can include a display on a sampling head 210 or on the body 220 of a sampling wand 200 that visually displays the number of desorption cycles to the operator. The incremental counter can include a unique identifier that is positioned within a sampling head 210 or a sampling frame that holds a substrate 240 within a sampling head 210. The unique identifier can be arranged to be detected by a counter or control system within an IMS analyzer 10 and/or body 220 of a sampling wand 200 that counts the number of desorption cycles for a sampling head 210 and/or substrate 240. The counter or control system can then output the number of desorption cyclones to the display of a sampling wand 200, such as by wired or wireless transmission. For example, radio frequency signals can be used to transmit information between the unique identifier, counter or control unit, and display. The incremental counter can be arranged to display a warning to an operator once the number of desorption cycles has reached a predetermined number indicating a limit for a sampling head 210 and/or substrate 240. Once this warning is displayed, an operator can replace a sampling head 210 and/or substrate 240 and reset the incremental counter. For example, an operator can reset the incremental counter by resetting the counter on the device or by resetting the counter on the analytical device. In one embodiment, the analytical device includes a touch screen which is used to reset the incremental counter.

Another example of a sample collection device is a manual sampling substrate. A manual sampling substrate can be a substrate made of a rigid or stiff material. In one embodiment, a manual sampling substrate can be made of fiberglass. A manual sampling substrate can optionally be coated with, for example, Teflon®.

An article to be tested can include any person or object. For example, an article can be a personal effect, clothing, bag, luggage, furniture, automobile interior, pharmaceutical process equipment, etc. Alternatively, an environment to be sampled can be pumped through a substrate to collect a sample.

A shape of a manual sampling substrate can be, without limitation, circular, oval, square, rectangular, or any other shape suitable to purpose of a manual sampling substrate. In regard to the dimensions of a manual sampling substrate, the length would be the largest dimension of a manual sampling substrate, the width would be the dimension transverse to the length, and the thickness would be the dimension transverse to both the width and length passing through a manual sampling substrate itself.

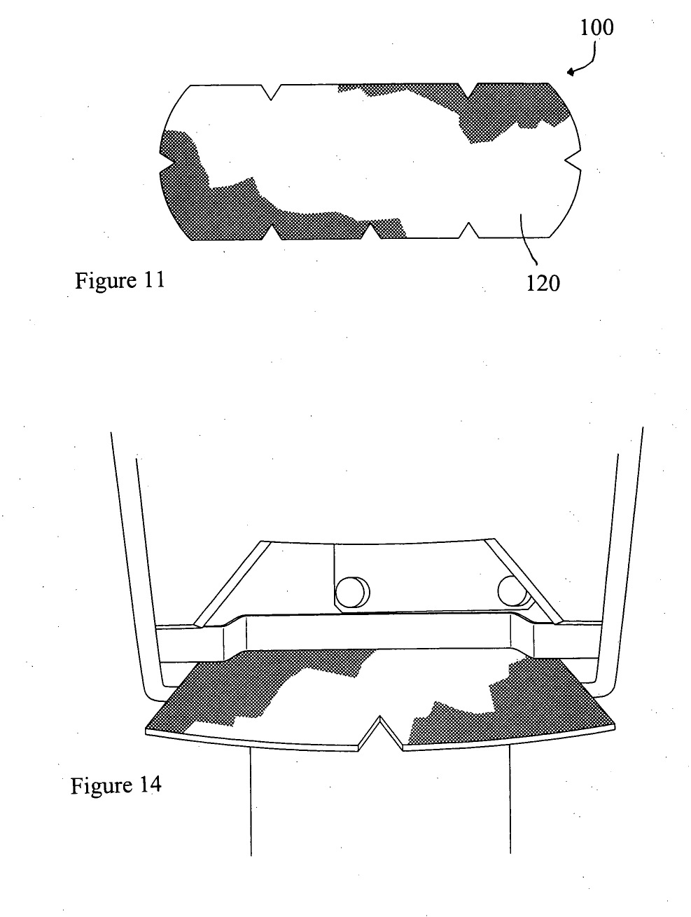

FIG. 11 is a perspective view of a manual sampling substrate, according to another embodiment. A manual sampling substrate 100 can include at least one sample collection area 120. A sample collection area 120 is a portion of a manual sampling substrate 100 that is positioned on a substrate 100 to allow desorption of a sample once a substrate 100 is inserted into an IMS analyzer. Samples can be collected within a sample collection areas of a manual sampling substrate 100 and/or other areas outside sample collection areas 120.

When a manual sampling substrate 100 is interfaced with an IMS analyzer, a sample collection area 120 can be aligned within an IMS analyzer for optimal or substantially optimal introduction of a sample in a sample collection area 120 to the IMS analyzer.

A manual sampling substrate 100 can interface with a sample receiving device of an IMS analyzer so that a sample collection area 120 is aligned or substantially aligned within an IMS analyzer so that a sample can be desorbed or substantially desorbed from a sample collection area 120. For example, a manual sampling substrate 100 can interface with grooves or other features of a sample receiving device to align a manual sampling substrate 100 within an IMS analyzer.

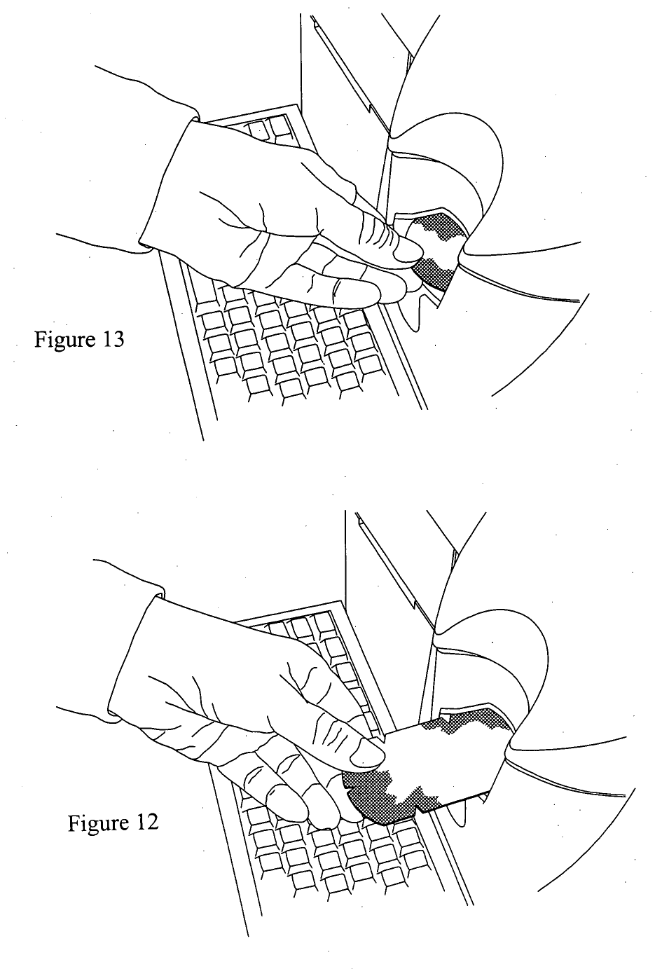

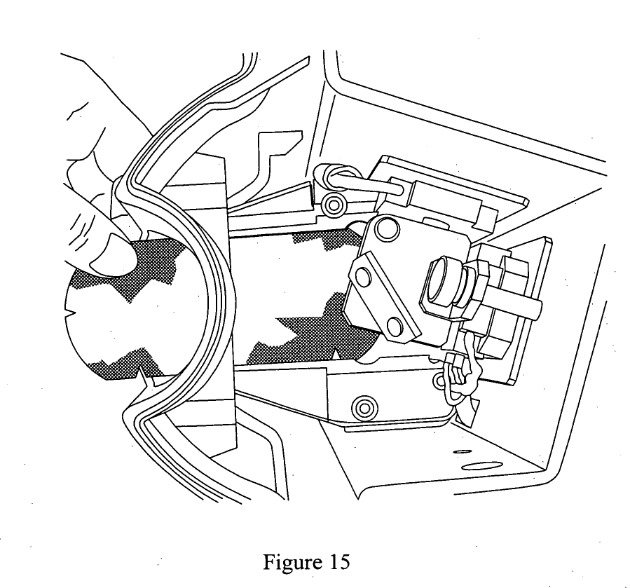

FIGS. 12-15 illustrate an embodiment of a manual sampling substrate. FIG. 12 partial insertion of a manual sampling substrate into an IMS analyzer. FIG. 13 illustrates complete insertion of a manual sampling substrate into an IMS analyzer. FIG. 14 shows a view from an end of a manual sampling substrate after the manual sampling substrate is inserted into an IMS analyzer. FIG. 15 is a top view showing a manual sampling substrate inserted into an IMS analyzer, with the cover of the IMS analyzer has been removed to show an exemplary interface of a manual sampling substrate with the IMS analyzer.

An IM spectrometer can include a drift tube, one or more devices to introduce reagents, an ionization region, an ionization source, and a detector.

An IM spectrometer can be operated using different instrument parameters and reagents to allow detection of a wide range of explosives, narcotics, CW agents, man-made substances, and industrial chemicals. In an embodiment, a CPU 70 can be configured to provide alarms for particular substances. For example, a CPU 70 can be configured to provide an alarm based upon a signal from one or both detectors. In a further embodiment, a CPU 70 can be configured to provide alarms through an operator interface 40.

Explosives can be detected in negative mode while narcotics can be detected in positive ion mode. According to an embodiment, a first IM spectrometer can be operated in positive ion mode and a second IM spectrometer can be operated in negative ion mode to facilitate detection of explosives and narcotics. Each IM spectrometer can independently operate at specific operating conditions, such as, for example, electric field gradient, drift tube temperature, inlet temperature, reactant temperature, calibrant temperature, drift gas flow, sample gas flow, reactant flow, and calibrant flow to provide enhanced sensitivity and/or selectivity for particular substances.

Some substances, such as temperature labile substances, can be detected at relatively low temperatures. Other substances, such as refractory or non-volatile substances, can be detected at elevated temperatures. According to an embodiment, a first IM spectrometer can be operated in positive ion mode at an elevated temperature, such as, for example, up to about 300° C. or more, while a second IM spectrometer can be operated in positive ion mode at a reduced temperature, such as, for example, approximately 50° C. to approximately 100° C. This permits detection of temperature labile substances without substantially compromising detection of refractory or non-volatile substances. Substances which can be detected at low temperature include, for example, taggants, ethylene glycol dinitrate (EGDN), and dimethyl dinitrobutane (DMNB). According to an embodiment, a first IM spectrometer can be operated in negative ion mode at a temperature of approximately 100° C. to approximately 110° C. while a second IM spectrometer can be operated in negative ion mode at a temperature of approximately 50° C. to approximately 70° C.

Some substances can be difficult to detect accurately because of false positive readings. For example, peroxide explosives, such as TATP, can be susceptible to false positive readings. According to an embodiment, an IMS analyzer can be configured so that each IM spectrometer provides a reading of a substance to verify a positive reading for a substance. For example, a first IM spectrometer can be operated in positive ion mode with a chemical ionization reagent, such as nicotinamide or isobutyramide, while a second IM spectrometer can be operated in negative ion mode with a chemical ionization reagent, such as a chloride chemical ionization reagent, to allow detection of a substance by both IM spectrometers and reduce the occurrence of false alarms.

In general, it can be desirable to detect multiple peaks for a target substance in order to decrease the occurrence of false alarms, particularly when dealing with a highly complex sample matrix that contains several analytes. Such complex sample matrices can be encountered when screening luggage and people. Therefore, it can be advantageous to perform analysis of a sample using an IM spectrometer operating in both positive and negative modes. This can be achieved by using a single spectrometer that can operate in both modes to analyze a sample, or by using multiples spectrometers, wherein the multiple spectrometers can operate in different modes.

with IM spectrometers operating in different modes so that a second spectrometer can verify the presence of an analyte that is detected by a first spectrometer, thereby reducing the occurrence of false alarms.

In one embodiment, each IM spectrometer can be independently controlled with respect to electric field polarity, electric field gradient, drift tube temperature, inlet temperature, reactant temperature, calibrant temperature, drift gas flow, sample gas flow, reactant flow, and calibrant flow. An IM spectrometer can be capable of analyzing for an extended range of analytes simultaneously in a sample. An IM spectrometer can be configured to detect a variety of substances in positive ion mode and negative ion mode simultaneously from a single sample.

The desorber can be capable of ramping from a preset temperature to higher operating temperature so that thermally labile analytes can be analyzed simultaneously with more refractory, non-volatile molecules. In one embodiment, the desorber can be capable of ramping from a present temperature to approximately 400° C. in 4 seconds. In another embodiment, the desorber can be capable of ramping from a present temperature to approximately 350° C.

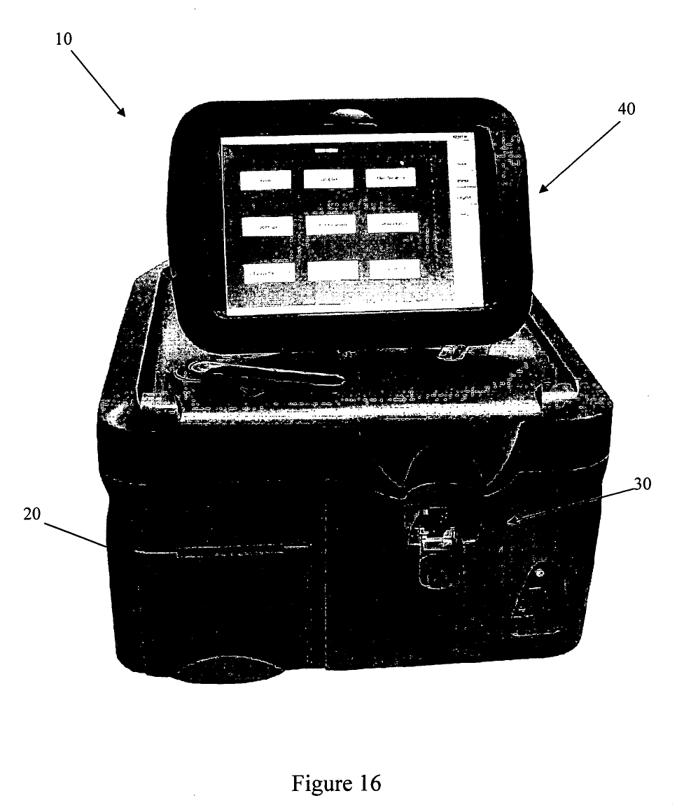

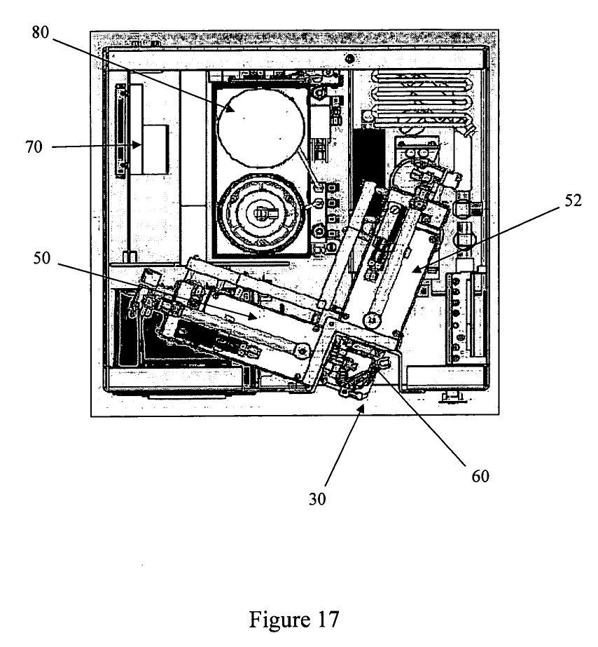

FIGS. 16 and 17 show an exemplary IMS analyzer. FIG. 16 is a perspective view of an IMS analyzer 10. FIG. 17 is a sectional view of an IMS analyzer 10 from the top, showing components of an IMS analyzer 10 according to an embodiment. An IMS analyzer 10 can include a housing 20 to enclose components of an IMS analyzer, a sample insertion area 30, and an operator interface 40. An operator interface 40 can be used to permit an operator to select commands for an IMS analyzer 10 and/or to display analysis results of samples. The operator interface 40 can be a touch-screen monitor. In other embodiments an operator interface 40 can include a monitor, keyboard, mouse, printer, or any combination of these components.

In one embodiment an IMS analyzer can include a first IM spectrometer 50 and a second IM spectrometer 52, a central processing unit (CPU) 70, and an air purification system 80. A sample insertion area 30 can include a desorber 60 for desorbing a sample from a sample collection device.

An IMS analyzer 10 can include an air purification system 80 that purifies air that is flowed through the IM spectrometers. An air purification system 80 can use replaceable filters or can be a self-regenerating system. For example, an air purification system can be raised to a suitable temperature for baking out impurities in an air purification system. For example, an air purification system 80 may be raised to a temperature of at least approximately 300° C. to bake out impurities. IM spectrometers 50, 52 may also be raised to a suitable baking temperature to bake out impurities.

As discussed previously, an IMS analyzer 10 can be configured to perform analysis of a sample once an operator has commanded an IMS analyzer 10 to begin analysis. For example, an operator can provide a command to begin analysis using an operator interface 40, which provides a command signal to a CPU 70. An IMS analyzer 10 can include a CPU 70 that controls functions of an IMS analyzer 10. For example, a CPU 70 can be arranged to control desorption of a sample, analysis of a sample, and/or interfacing with an operator.

A sample can be introduced by desorption. A desorber 60 can comprise a heated anvil. According to an embodiment, a CPU 70 can be configured to control a desorber. Once a sample has been converted to vapor form within a desorber 60, a sample can be conveyed from a desorber 60 to at least one of IM spectrometers 50, 52. In one embodiment, a gas flow can be used to convey a sample from a desorber 60 to IM spectrometers 50, 52. In another embodiment, a sample can be divided into two portions (a 50:50 ratio), wherein each portion is sent to one IM spectrometer. In another embodiment, a sample can be divided into portions of differing ratios. For example, a sample may be split into portions with ratios of about 60:40, 70:30, 80:20, 90:10, or 100:0. According to an embodiment, ratios of sample portions can be set as constants or the ratios may be controlled in relation to the operating conditions of the IM spectrometers, such as, for example, polarity, temperature, or any parameter that can be independently controlled for a spectrometer. According to an embodiment, a CPU 70 can be configured to control a ratio of sample portions.

Each spectrometer 50, 52 can include an ionization device. In one embodiment, an ionization device is a ⁶³Ni ionization source. In another embodiment, an ionization device is a ⁶³Ni, corona discharge device. According to another embodiment, an ionization device is a ⁶³Ni and a corona discharge ionization device. According to another embodiment, an ionization device can be Americium 241. According to an embodiment, each spectrometer 50, 52 can have one ionization source. In one embodiment, the ionization source for each spectrometer is the same. In another embodiment, the ionization source for each spectrometer is different.

A first detector 50 and a second IM spectrometer 52 can be independently controlled with respect to polarity, electric field gradient, drift tube temperature, inlet temperature, reactant temperature, calibrant temperature, drift gas flow, sample gas flow, reactant flow, and calibrant flow. For example, the temperatures of the IM spectrometers can be independently controlled between approximately 50° C. and approximately 400° C. or more. In another example, the temperatures of IM spectrometers 50, 52 can be controlled at approximately 114° C. to approximately 224° C. in a dual mode for detecting illicit drugs and explosives. In another example, IM spectrometers 50, 52 can be used in the same mode, such as, for example, a negative mode, with one detector set at approximately 60 to approximately 70° C. in order to detect volatile explosives.

Reagents can be used with an IM spectrometer to enhance detection of analytes. Reagents can be used to enhance the ionization characteristics of analytes, permitting enhanced detection of analytes. In general, reagents can be used to control proton transfer in positive mode and anion-attachment in negative mode. Reagent gases that can be used with an IM spectrometer in positive mode include acetone, benzene, ammonia, dimethylsulfoxide (DMSO), nicotinamide, and isobutyramide. Small chlorinated hydrocarbons can be used to produce chloride ions for an IM spectrometer in negative mode. For example, chloroform, methylene chloride, hexachloroethane and other chlorinated hydrocarbons can be used in negative mode to provide chloride ions. Furthermore, by selectively clustering with appropriate reagents, peak separation can be enhanced. Reagents can be introduced into an IM spectrometer by introducing a reagent in vapor form. For example, a reagent can be introduced directly into a reaction region of a drift tube, a carrier gas stream, or a carrier gas stream and drift gas stream. Permeation sources can be used to provide a continuous source of a reagent. An example of a permeation source is a chemical, often in liquid or solid form, housed in a container that permits the chemical to permeate through a wall of the container at a rate that depends upon the material of the container wall, the container wall thickness, container length, vapor pressure of the chemical, and temperature.

Reagent ionization can be used to detect particular substances or to provide a configuration that permits broad detection of substances. According to an embodiment, a first IM spectrometer can be operated in positive ion mode with an ionization reagent, such as nicotinamide chemical ionization reagent, to permit detection of substances that will undergo proton transfer with an ionization agent due to the substance having a proton affinity that is equal to or higher than an ionization agent. Furthermore, a second IM spectrometer can be operated in positive ion mode with a water reagent or other ionization reagent that will ionize via charge transfer, proton transfer, clustering reactions, or other ion-molecule reactions to detect substances that are easily ionized by one of these mechanisms.

Oxygen chemistry can also be used to detect a range of substances that do not efficiently ionize in other ways, such as chloride chemistry. According to an embodiment, a first IM spectrometer can be operated in negative ion mode with a non-oxygen ionization reagent, such as a chloride chemical ionization reagent, while a second IM spectrometer can be operated in negative ion mode with an-oxygen or other suitable chemical ionization reagent to permit detection of a broad range of substances.

Other combinations and variations of these configurations are possible, depending on the application and the substance being monitored.

Table 1 provides exemplary configurations for an IMS system having two IM spectrometers.

TABLE 1
Exemplary dual IMS configurations.

| IMS tube 1 | IMS tube 2 | Advantage |
|---|---|---|
| Positive mode, high proton | Negative mode with | Detects both narcotics and |
| affinity reagent, | chloride reagent, | explosives simultaneously |
| Temperature 100-300° C. | temperature 90-110° C. | |
| Positive ion mode, high | Positive mode, low | Detects labile drugs or |
| temperature | temperature | other substances |
| Negative mode, chloride | Negative mode, chloride | Detection of taggants and |
| reagent, temperature 100-110° C. | reagent, temperature 50-70° C. | traditional explosives |
| Positive mode with | Negative mode, with | Detects peroxide |
| nicotinamide or | chloride Cl reagent | explosives |
| isobutyramide reagent | | |
| Positive mode with | Positive mode with water or | Detection of high and low |
| nicotinamide reagent | other Cl reagents | proton affinity substances |
| Negative mode with | Negative mode with oxygen | Detection of high and low |
| chloride | or other Cl reagents | electron affinity |
| | | compounds |

The following examples are illustrative. It should be understood, however, that the invention, as claimed, is not limited to the specific embodiments described in these examples. It will be apparent to those skilled in the art that various modifications and variations can be made to the embodiments of the claimed invention without departing from the spirit or scope of the claimed invention. Thus, it is intended that the claimed invention covers other modifications and variations of this invention within the scope of the appended claims and their equivalents.

### EXAMPLE 1

### Distinguishing between the Detection Peak Patterns of Ranitidine and Cocaine

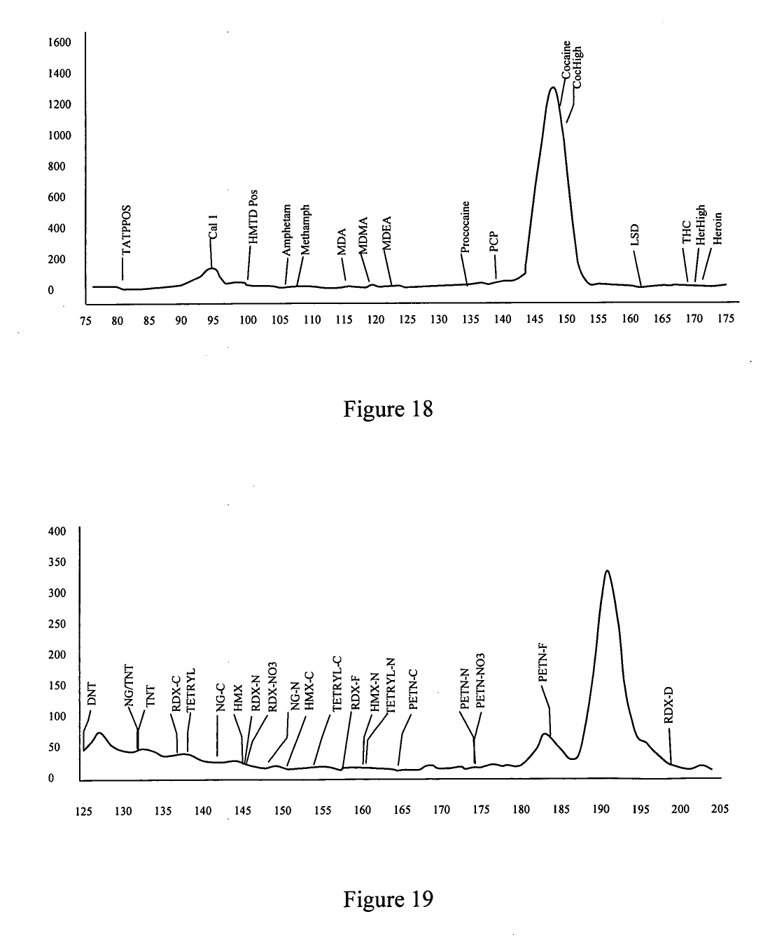

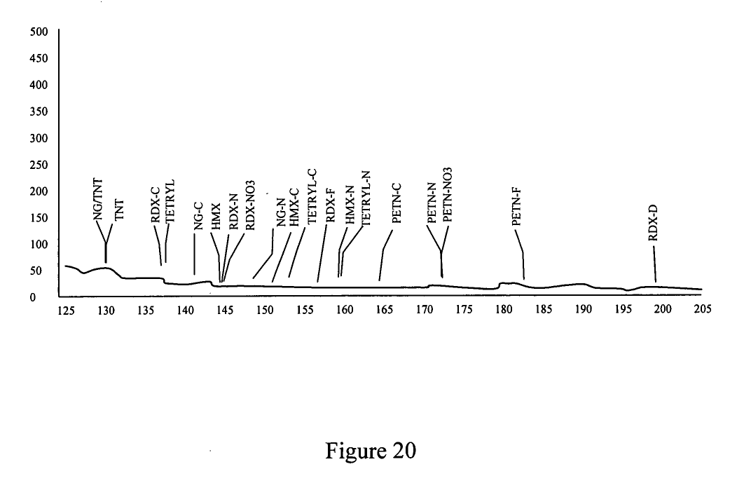

This example demonstrates how substances that cannot be distinguished in a single mode, such as, for example, positive mode, can be distinguished from one another when analyzed in both polarity modes. For example, ranitidine and cocaine have similar mobility constants in the positive mode. However, only ranitidine is ionized in the negative ion mode. FIGS. 18-20 show detection peak patterns that were obtained using an Ionscan® 500 DT ion mobility spectrometer (Smith Detection, Inc.) run with the parameters shown in Table 2. FIG. 18 shows a detection peak pattern for Ranitidine in positive mode as shown. A detection peak for cocaine is also shown in FIG. 18. FIG. 19 shows a detection peak pattern for Ranitidine in negative ion mode. However, FIG. 19 does not show a detection peak for cocaine. FIG. 20 shows a detection peak pattern for cocaine in the negative ion mode.

TABLE 2
Ionscan ® Instrument Parameters

| Parameter | Negative Mode | Positive Mode |
|---|---|---|
| Drift tube temperature (° C.) | 105 | 228 |
| Inlet temperature (° C.) | 240 | 285 |
| Desorber temperature (° C.) | 225 | 285 |
| Calibrant block temperature (° C.) | 63 | 70 |
| Drift flow rate (cc/min) | 350 | 300 |
| Desorption flow rate (cc/min) | 200 | 200 |
| Bake out temperature (° C.) | 245-265 | 275-280 |
| Analysis delay following start | 0.025 | 0.100 |
| desorption (seconds) | | |
| Scan period (milliseconds) | 22 varied | 20 |
| | to 50 msec | |
| Shutter grid width (microseconds) | 200 | 200 |
| Analysis duration (seconds) | 5-60 | 5-60 |
| Maximum number of segments per | 15 (for 6.6 seconds) | 20 |
| analysis | | |
| Number of co-added scans per | 20 | 20 |
| segment | | |
| Number of sample points per scan | 419 | 379 |
| Calibrant or reference compound | 4-nitrobenzonitrile | Nicotinamide |
| Ionization reagent | Hexachloroethane | Nicotinamide |

### EXAMPLE 2

### Detection of Ammonium Nitrate

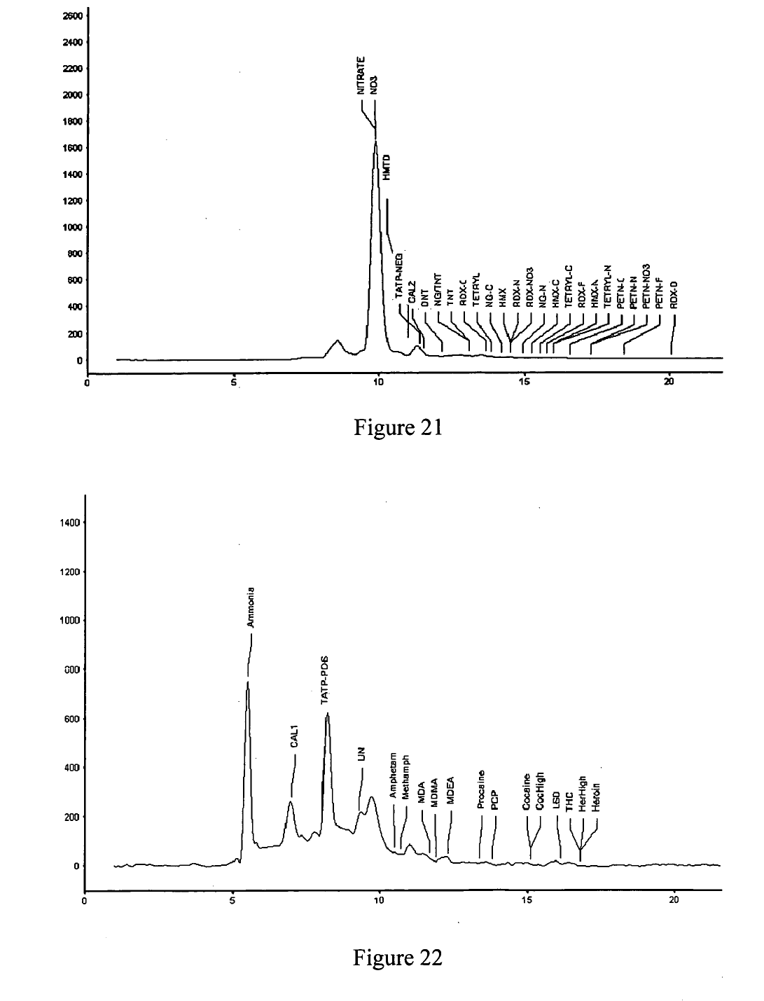

Ammonium nitrate can be difficult to distinguish from other analytes containing ammonium ions or nitrate ions. An IMS analyzer can be configured so that one IM spectrometer detects the nitrate peak in negative ion mode and the other IM spectrometer detects the ammonium peak in positive ion mode, permitting positive detection of ammonium nitrate. FIGS. 21 and 22 show detection peak patterns that were obtained using an Ionscan® 500 DT ion mobility spectrometer (Smith Detection, Inc.) run with the parameters shown in Table 2. FIG. 21 shows a detection peak pattern for ammonium in positive ion mode. FIG. 22 shows a detection peak pattern for nitrate in negative ion mode.

### EXAMPLE 3

### Examples of Detection Limits for an IMS Analyzer

This example demonstrates exemplary detection limits for explosive and narcotic compounds. Explosive compounds are run in an Ionscan® 500 DT ion mobility spectrometer (Smith Detection, Inc.) in negative mode using the parameters set forth in Table 2.

Narcotics compounds are run in an Ionscan® 500 DT ion mobility spectrometer (Smith Detection, Inc.) in positive mode using the parameters set forth in Table 2:

TABLE 3
Exemplary Explosive and Narcotic Detection Limits

| Explosives Mode | Narcotics Mode |
|---|---|
| RDX 0.5 ng | Cocaine 0.5 ng |
| PETN 0.5 ng | Heroin 3 ng |
| NG 1 ng | Amphetamine 0.5 ng |
| TNT 0.3 ng | Methamphetamine 0.5 ng |
| Ammonium nitrate 10 ng | Ammonium nitrate 1 ng |
| DNT 0.5 ng | MDA 0.3 ng |
| HMX 20 ng | MDMA 0.3 ng |
| HMTD 20 ng | HMTD 2 ng |
| TATP 300 ng | TATP 10 ng |
| Tetryl 0.5 ng | THC 0.5 ng |
| Semtex H 0.5 ng | LSD 4 ng |
| C4 formulation 0.5 ng | PCP 0.3 ng |

What is claimed is:

1. A sample receiving device comprising:
a sample introduction area where a sample is positioned for introduction into an analytical device, and a guide structure that receives a sample collection device within the sample receiving device, wherein the sample collection device is properly aligned within the analytical device for optimal or substantially optimal introduction of the sample on the sample collection device into the analytical device.

2. The sample receiving device of claim 1, wherein the analytical device is an IMS, an IMS/IMS, or a gas chromatography/IMS.

3. The sample receiving device of claim 1, wherein the sample collection device is a manual sampling substrate.

4. The sample receiving device of claim 3, wherein the sample receiving device is arranged so that insertion of the manual sampling substrate initiates analysis of the sample.

5. The sample receiving device of claim 1, wherein the sample collection device is a sampling wand with a sampling head.

6. The sample receiving device of claim 5, further comprising a locking mechanism that locks the sampling head in position within the sample receiving device.

7. The sample receiving device of claim 5, wherein further comprising a mechanism arranged to count a number of desorption cycles for a substrate or sampling head.

8. An ion mobility spectrometry system, comprising:
an ion mobility spectometer,
a sample receiving device, wherein the sample receiving device includes a sample introduction area where a sample is positioned for introduction into an analytical device, and a guide structure that receives a sample collection device within the sample receiving device, wherein the sample collection device is properly aligned within the analytical device for optimal or substantially optimal introduction of the sample on the sample collection device into the analytical device, and
a desorber.

9. The ion mobility spectrometry system of claim 8, wherein the sample collection device is a manual sampling substrate.

10. The ion mobility spectrometry system of claim 8, wherein the sample receiving device is arranged so that insertion of the sample collection device initiates desorption of the sample from the sample collection device.

11. The ion mobility spectrometry system of claim 8, wherein the sample collection device is a sampling wand with a sampling head.

12. The ion mobility spectrometry system of claim 11, further comprising a locking mechanism that locks the sampling head in position within the sample receiving device.

13. The ion mobility spectrometry system of claim 11, further comprising a mechanism arranged to count a number of desorption cycles for a substrate or sampling head.

14. The ion mobility spectrometry system of claim 8, wherein the ion mobility spectrometer is a first ion mobility spectrometer, further comprising a second ion mobility spectrometer.

15. The ion mobility spectrometry system of claim 14, wherein the first and second ion mobility spectrometers are adapted to be independently controlled with respect to parameters selected from the group consisting of electric field polarity, electric field gradient, a drift tube temperature, inlet temperature, reactant temperature, calibrant temperature, drift gas flow, sample gas flow, reactant flow, and calibrant flow.

16. The ion mobility spectrometry system of claim 15, wherein the first ion mobility spectrometer operates in positive ion mode at a temperature up to approximately 300° C. or more and the second ion mobility spectrometer operates in positive ion mode at a temperature of approximately 50° C. to approximately 100° C.

17. The ion mobility spectrometry system of claim 15, wherein the first ion mobility spectrometer operates in negative ion mode at a temperature of approximately 100° C. to approximately 110° C. and the second ion mobility spectrometer operates in negative ion mode at a temperature of approximately 50° C. to approximately 70° C.

18. The ion mobility spectrometry system of claim 14, wherein the first ion mobility spectrometer operates in positive ion mode using a first chemical ionization reagent, and the second ion mobility spectrometer operates in negative ion mode using a second chemical ionization reagent.

19. The ion mobility spectrometry system according to claim 18, wherein the first chemical ionization reagent is nicotinamide or isobutyramide, and wherein the second chemical ionization reagent is a chloride chemical ionization reagent.

20. The ion mobility spectrometry system of claim 14, wherein the first ion mobility spectrometer operates in positive ion mode using a first ionization reagent to permit detection of analytes that will undergo proton transfer with the first ionization agent, and wherein the second ion mobility spectrometer operates in positive ion mode with a second ionization reagent that will ionize via charge transfer, proton transfer, or clustering reactions with a second ionization agent.

21. The ion mobility spectrometry system of claim 20, wherein the first chemical ionization reagent is nicotinamide.

22. The ion mobility spectrometry system of claim 14, wherein the first ion mobility spectrometer operates in negative ion mode with a non-oxygen ionization reagent and the second ion mobility spectrometer operates in negative ion mode with an oxygen reagent.

23. The ion mobility spectrometry system of to claim 22, wherein the non-oxygen ionization reagent is a chloride chemical ionization reagent.

24. The ion mobility spectrometry system of claim 8, wherein the desorber is a heated anvil.

25. The ion mobility spectrometry system of claim 24, wherein the first and second ion mobility spectrometers are in fluid connection with the desorber, and wherein the system is adapted to control a ratio of the sample conveyed to each of the first and second ion mobility spectrometers.

26. The ion mobility spectrometry system of claim 8, wherein the ion mobility spectrometry system is configured to automatically begin desorption and analysis of a sample when the sample collection device is inserted into the sample receiving device.

27. The ion mobility spectrometry system of claim 8, further comprising a ⁶³Ni, ²⁴¹Americium, or corona discharge ionization source.

28. The ion mobility spectrometry system of claim 8, further comprising a ⁶³Ni and a corona discharge ionization source.

29. An ion mobility spectrometry system, comprising:
a first ion mobility spectrometer, comprising a drift tube, a reagent introduction device, an ionization region, an ionization source, and a detector;
a second ion mobility spectrometer, comprising a drift tube, a reagent introduction device, an ionization region, an ionization source, and a detector;
at least one ionization source; and
a sample receiving device for receiving a sample collection device, wherein the sample receiving device includes a sample introduction area where a sample is positioned for introduction and analysis, and a guide structure that receives and aligns the sample collection device within the sample receiving device, wherein the sample collection device is properly aligned within the system for optimal or substantially optimal introduction of the sample on the sample collection device.
